(19) United States
(12) Patent Application Publication
(10) Pub. No.: US 2017/0085612 A1
(43) Pub. Date: Mar. 23, 2017

(54) System and Method for Wireless Video Playback

(71) Applicant: Chandrasekaran Rajendran, Owings Mills, MD (US)

(72) Inventor: Chandrasekaran Rajendran, Owings Mills, MD (US)

(21) Appl. No.: 15/268,903

(22) Filed: Sep. 19, 2016

Related U.S. Application Data
(60) Provisional application No. 62/221,853, filed on Sep. 22, 2015.

(51) Int. Cl. H04L 29/06; H04W 12/06

(52) U.S. Cl. CPC H04L 65/60; H04W 12/06; H04N 5/44

(57) ABSTRACT

A system and method for wireless video playback. The system includes a wireless video player having a wireless transceiver, a connector port, a disk drive, a processor, a non-transitory computer readable medium operatively connected to the processor, and a logic stored in the non-transitory medium. When the logic is executed by the processor, the logic causes the wireless video player to perform a method. The method includes the steps of authenticating one or more external devices, receiving a playback command from a controller, receiving identifying information of the external devices, commencing playback of a video disk in the disk drive, and wirelessly transmitting the playback of the video to the external devices via the system's wireless network. The wireless video player allows users to wirelessly transmit the playback of a DVD to multiple external devices having a display for viewing video.

### CROSS REFERENCE TO RELATED APPLICATIONS

This application claims the benefit of U.S. Provisional Application No. 62/221,853 filed on Sep. 22, 2015. The above identified patent application is herein incorporated by reference in its entirety to provide continuity of disclosure.

### BACKGROUND OF THE INVENTION

The present invention relates to a video player. More specifically, the present invention relates to a video player having a disk tray that wirelessly streams video playback from the disk to one or more external devices.

Many individuals enjoy viewing video playback for both recreational and educational purposes. Conventional DVD and other video players only allow individuals to watch video on a single connected device. This prevents others from enjoying the DVD on other devices. Additionally, most video players require a wired connection to a display, which can be inconvenient. Therefore, there exists a need for a system and method of wirelessly transmitting video playback from a DVD or other source to multiple displays.

Devices have been disclosed in the prior art that relate to wireless video players. These include devices that have been patented and published in patent application publications. These devices generally relate to video transmitting and streaming devices, such as U.S. Patent Publication Number 2013/0201907, U.S. Pat. No. 7,716,699, U.S. Patent Publication Number 2005/0076304, U.S. Patent Publication Number 2004/0250273, and U.S. Patent Publication Number 2011/0158146.

These prior art devices have several known drawbacks. While the prior art devices provide a means for streaming video, these devices do not provide a system that reads a video disk and wirelessly transmits the playback of the disk contents to external devices, wherein the system includes a disk drive, a wireless transceiver, an Ethernet port, and a USB port.

In light of the devices disclosed in the prior art, it is submitted that the present invention substantially diverges in design elements from the prior art and consequently it is clear that there is a need in the art for an improvement to existing video playback devices. In this regard the instant invention substantially fulfills these needs.

### SUMMARY OF THE INVENTION

In view of the foregoing disadvantages inherent in the known types of video players now present in the prior art, the present invention provides a video player wherein the same can be utilized for providing convenience for the user when wirelessly transmitting video playback to an external viewing device. The wireless video player includes a wireless transceiver that generates a Wifi network, a connector port, a disk drive, a processor, a non-transitory computer readable medium operatively connected to the processor, and a logic stored in the non-transitory medium that, when executed by the processor, causes the wireless video player to perform a method. The method includes the steps receiving identification information of one or more streaming devices and authenticating the one or more streaming devices. If the one or more streaming devices are not authenticated, then the authentication step is repeated; if the one or more streaming devices are authenticated, then: receiving a playback command from a controller, receiving identifying information of one or more external devices, commencing playback of a video disk in the disk drive, and wirelessly transmitting the playback of the video to the one or more external streaming devices via a wireless network generated by the wireless video player.

One object of the present invention is to provide a wireless video playback system that allows individuals to watch a DVD on multiple devices.

Another object of the present invention is to provide a wireless video playback system having inputs for receiving video information.

Other objects, features, and advantages of the present invention will become apparent from the following detailed description taken in conjunction with accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of the system for wireless video playback according to the present invention.

FIG. 2 shows a flowchart of the steps of the method of wireless video playback according to the present invention.

### DETAILED DESCRIPTION OF THE INVENTION

Reference is made herein to the attached drawings. Like reference numerals are used throughout the drawings to depict like or similar elements of the system and method for wireless video playback. For the purposes of presenting a brief and clear description of the present invention, the preferred embodiment will be discussed as used for wirelessly transmitting video to one or more streaming devices. The figures are intended for representative purposes only and should not be considered to be limiting in any respect.

As used herein, “logic” refers to (i) logic implemented as computer instructions and/or data within one or more computer processes and/or (ii) logic implemented in electronic circuitry.

As used herein, “computer-readable medium” excludes any transitory signals, but includes any non-transitory data storage circuitry, e.g., buffers, cache, and queues, within transceivers of transitory signals.

According to some embodiments, the operations, techniques, and/or components described herein can be implemented by an electronic device, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that incorporates hard-wired and/or program logic to implement the techniques and other features of the present disclosure.

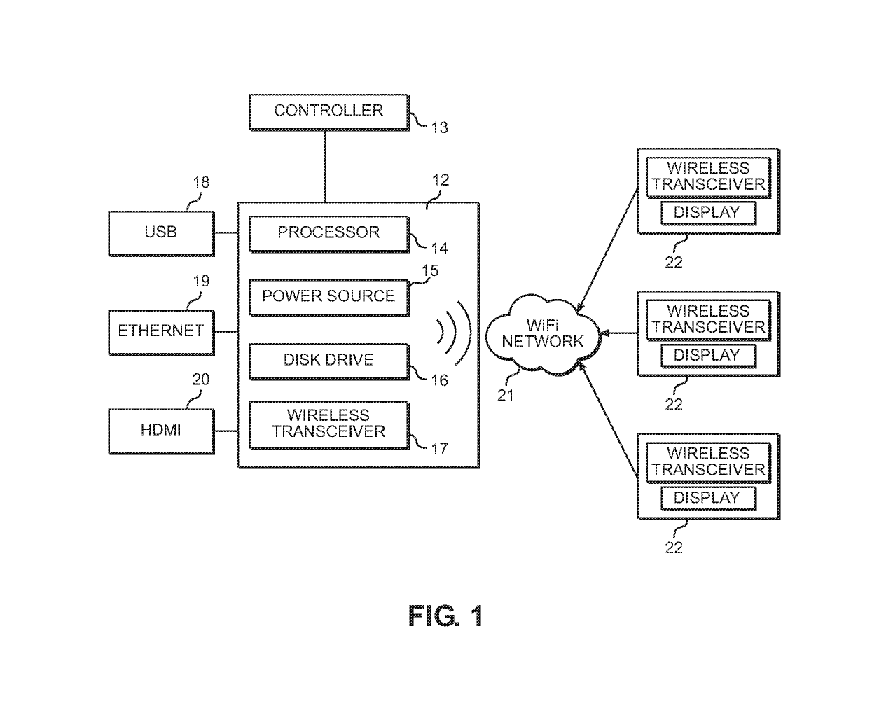

Referring now to FIG. 1, there is shown a diagram of the system for wireless video playback according to the present invention. The present system includes a wireless video player having a processor 14, a power source 15, a disk drive 16, and a wireless transceiver 17 configured to create a Wifi network. The system is preferably embodied in a housing supportable on a horizontal surface. The system further includes various inputs that can be utilized to provide source video or audio from other devices such as a computer, laptop, smartphone, or the like. The video received from either the disk drive 16 or external inputs is transmitted via a wireless network 21 to a connected streaming device 22. The network 21 is a Wi-Fi network, LAN, or other type of existing network that facilitates wireless communication between devices connected to said network. The connected streaming device 22 includes at least a wireless transceiver for receiving the video or audio information and a display having a screen and speakers for playing back the video or audio information.

The controller 13 is configured to control the various operational features of the wireless video playback device. In one embodiment of the invention, the controller is a remote controller in wireless communication with the wireless video playback device. In an alternative embodiment, the controller 13 comprises buttons disposed on an exterior surface of the housing of the wireless video playback system. In another alternative embodiment, the controller can be a smart phone or other device capable of wirelessly transmitting commands to the wireless video playback system.

The processor 14 includes additional components such as a memory and a logic stored therein. The logic, when executed by the processor, causes the wireless video playback device to perform its intended function of real time streaming of video stored on a disc such as a DVD or Blu-ray. The power source 15 provides electrical power to the wireless video playback device. The power source 15 can be embodied in either an electrical connection with a wall outlet or a rechargeable battery. Additionally, the disk drive 16 is configured to read information stored on discs such as DVD's, blu ray, etc.

In one embodiment of the invention, the wireless video playback system includes a plurality of external connector ports for optionally providing wired playback or for the transference of additional information wirelessly the wireless video playback system. In the illustrated embodiment, the connector ports include a USB port 18, an Ethernet port 19, and an HDMI port 20. This allows the wireless video player to receive video information from external sources and provides for the wireless playback of video from locations other than a DVD, such as streaming services, video files stored on a computer, or video files stored on a server accessible via the internet. In an alternate embodiment, the connector ports further include a WAN port.

The wireless transceiver 17 is configured to generate a Wifi network to transmit the video from the disk drive 16 or one of the connector ports to one or more connected streaming devices 22. The connected streaming devices 22 each have a wireless transceiver in order to receive the video information from the wireless video player, and a display to play back the video information. The connected streaming devices 22 can include, but are not limited to, a smartphone, laptop, tablet, computer, or a television. The wireless video player may be configured to allow playback of the video on each device simultaneously. In an alternate embodiment of the invention, additional controllers may be provided for controlling the playback on each individual connected streaming device.

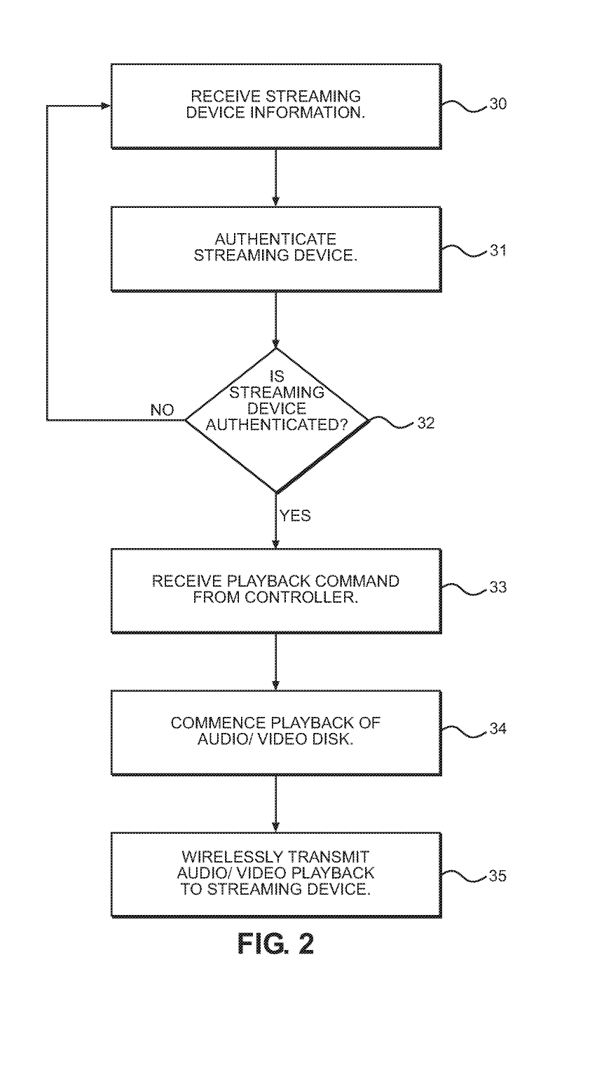

Referring now to FIG. 2, there is shown a flowchart of the steps of the method of wireless video playback according to the present invention. In a first step, the wireless video playback system receives 30 information regarding one or more streaming devices. The wireless transceiver is configured to recognize an external streaming device connected to the same wireless network as the wireless video playback system. Multiple streaming devices may be recognized at once. This allows the wireless video playback system to recognize and transmit video or audio to multiple external streaming devices. The information received from the one or more streaming devices includes identification information and verifies that the streaming device belongs to the owner of the wireless video playback system. Multiple identifiers for different streaming devices may be stored within the memory of the wireless video playback system.

A second step includes authenticating 31 the one or more streaming devices. The wireless video playback system compares the identification information received from the one or more streaming devices to the stored identifiers. If they match, the device is authenticated. If they do not match, the device is not authenticated and the system repeats the step of receiving identification information from the one or more streaming devices until a matching identification is received.

If the one or more streaming devices are authenticated, then playback of audio or video is permitted. In the next step, the wireless video playback system receives 31 playback commands from the controller. The playback command is configured to initiate and control playback of the video stored on the disk. The playback commands can include, but are not limited to, starting or stopping the video, fast-forwarding, rewinding, and the like. The playback commands can also initiate and control playback from devices connected via the USB port or other external inputs.

The next step of the method includes commencing 33 playback of the audio or video disk, or of the video file stored on any device connected to one of the connector ports. The video playback can be controlled by the controller of the wireless video playback system. Alternatively, each individual streaming device may have secondary controls for controlling the playback on that particular device.

A fourth step of the method includes wirelessly transmitting 34 the audio or video playback to the one or more streaming devices. The audio for video is wirelessly transmitted over a network generated by the wireless video playback system. The audio or video may be transmitted to each of the streaming devices simultaneously. Alternatively, the user may choose which of the particular streaming devices to transmit the video. In this way, users may wirelessly transmit video or audio to multiple displays simultaneously throughout a home for the enjoyment of multiple viewers.

A wireless video player allows individuals to transmit video or audio from a single source such as a DVD to a plurality of streaming devices over via a wireless transceiver. In this way, multiple displays may be utilized to play the same video or audio. The wireless video playback system therefore provides users with the capability of viewing a single audio or video source on multiple displays connected to a home network for entertainment or educational purposes.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wireless video player comprising:
a wireless transceiver;
a connector port for receiving an external input;
a disk drive;
a processor;
a non-transitory computer readable medium operatively connected to the processor;
a logic stored in the non-transitory computer readable medium that, when executed by the processor, causes the wireless video player to perform a method, the method comprising the steps of:
receiving identification information of one or more streaming devices;
authenticating the one or more streaming devices;
if the one or more streaming devices are not authenticated, then repeating the authentication step;
if the one or more streaming devices are authenticated, then:
receiving a playback command from a controller;
commencing playback of a video disk in the disk drive; and
wirelessly transmitting the playback of the video to the one or more streaming devices via a wireless network generated by the wireless video player.

2) The wireless video player of claim 1, wherein the connector port comprises an Ethernet port.

3) The wireless video player of claim 1, wherein the connector port comprises a USB port.

4) The wireless video player of claim 1, wherein the connector port comprises an HDMI port.

5) A non-transitory computer readable medium that, when executed by a processor of a wireless video player, causes the wireless video player to perform a method, the method comprising the steps of:
receiving identification information of one or more streaming devices;
authenticating the one or more streaming devices;
if the one or more streaming devices are not authenticated, then repeating the authentication step;
if the one or more streaming devices are authenticated, then:
receiving a playback command from a controller;
commencing playback of a video disk in the disk drive; and
wirelessly transmitting the playback of the video to the one or more streaming devices via a wireless network generated by the wireless video player.

6) A computer-implemented method comprising the steps of:
receiving identification information of one or more streaming devices;
authenticating the one or more streaming devices;
if the one or more streaming devices are not authenticated, then repeating the authentication step;
if the one or more streaming devices are authenticated, then:
receiving a playback command from a controller;
commencing playback of a video disk in the disk drive; and
wirelessly transmitting the playback of the video to the one or more streaming devices via a wireless network generated by the wireless video player.
